(19) United States
(12) Patent Application Publication
(10) Pub. No.: US 2018/0276664 A1
(43) Pub. Date: Sep. 27, 2018

(54) KEY DOWNLOAD METHOD AND APPARATUS FOR POS TERMINAL

(71) Applicant: PAX COMPUTER TECHNOLOGY (SHENZHEN) CO.,LTD., Shenzhen, Guangdong (CN)

(72) Inventors: Rongshou Peng, Shenzhen, Guangdong (CN); Yang Li, Shenzhen, Guangdong (CN); Qin Tang, Shenzhen, Guangdong (CN)

(21) Appl. No.: 15/556,647

(22) PCT Filed: Dec. 30, 2016
(86) PCT No.: PCT/CN2016/113757

§ 371 Date: Sep. 8, 2017

(30) Foreign Application Priority Data
Dec. 7, 2016 (CN) 201611115919.0

(51) Int. Cl. G06Q 20/38; H04L 9/08; H04L 9/14; H04L 9/32; H04L 9/30; H04L 29/06; G06Q 20/20

(52) U.S. Cl. CPC G06Q 20/3829; H04L 9/0819; H04L 9/14; H04L 9/3268; G06Q 2220/00; H04L 9/3213; H04L 63/0823; G06Q 20/206; H04L 63/083; H04L 9/30

(57) ABSTRACT

A key download method for a POS terminal, comprising: setting a device authentication key pair and a device encryption key pair in the POS terminal during a production or maintenance phase of the POS terminal; according to a remote authentication key pair set by a remote key server and the device authentication key pair of the POS terminal, the POS terminal and the remote key server authenticating each other; after the authentication succeeds, bounding a certificate of the remote key server to the POS terminal device; according to the device encryption key pair and a temporary transmission key, the POS terminal downloading the master key from the remote key server. The above method can download the master key through a network outside a security center, the security is high, the transportation cost can be saved, and the efficiency is high.

### TECHNICAL FIELD

The present application pertains to the field of security of POS terminals, and more particularly to a key download method and apparatus for a POS terminal.

### BACKGROUND

A POS (its English full name is Point of sales, and its Chinese full name is “ [symbol] ”, is a terminal reader equipped with a bar code or OCR code technology, and has the bank teller function of cash or barter. Its main task is to provide data services and management functions for goods and services transactions, and to process non-cash settlement. Because it includes a non-cash settlement function, the security of the POS terminal must be well ensured, for example, the security of the key of the POS terminal must be ensured.

In order to ensure the security of the keys of POS terminals, the current method is usually that: after a manufacturer delivers good to an acquirer institution, it is necessary to transport the POS terminals to the security center of the location of the acquirer institution, and keys are installed by the security center. After the completion of the key installation, the POS terminals are distributed to merchants. As the POS terminals need to be transported to the security center to perform the key installation after leaving the factory, and then distributed to the acquirer institution after the completion of the key installation, the operation of the key installation is troublesome, the cost of logistics costs increases, and the efficiency of key installation is low.

### SUMMARY

An object of the present application, among others, is to provide a key download method for a POS terminal, aiming to solve the problems in the prior art that the apparatuses need to be transported to the security center for performing key installation, the operation is troublesome, and that the logistics cost increases and the efficiency of key installation is low.

in a first aspect, one embodiment of the present application provides a key download method for a POS terminal, wherein the method comprises:

setting a device authentication key pair and a device encryption key pair in the POS terminal during a production or maintenance phase of the POS terminal;

according to a remote authentication key pair set by the remote key server and the device authentication key pair of the POS terminal, the POS terminal and the remote key server authenticating each other; after the authentication succeeds, bounding a certificate of the remote key server to the POS terminal device;

according to the device encryption key pair and a temporary transmission key, the POS terminal downloading a master key from the remote key server.

In connection with the first aspect, in the first possible embodiment of the first aspect, the step of setting the device authentication key pair and the device encryption key pair in the POS terminal specifically includes:

randomly generating the device authentication key pair and the device encryption key pair in the POS terminal, or randomly generating the device authentication key pair and the device encryption key pair by a manufacturer encryption machine, and sending a public key of the device authentication key pair and the device encryption key pair to a certificate registration authority to generate a device authentication key certificate and a device encryption certificate respectively.

In connection with the first aspect or the first possible embodiment of the first aspect, in a second possible embodiment of the first aspect, the step of setting the device authentication key pair and the device encryption key pair in the POS terminal includes:

the POS terminal sending a key setting request to a local key server, and the key setting request including a device identifier of the POS terminal;

the POS terminal receiving and verifying a local key server certificate sent by the local key server, and generating a first random number and a second random number when the authentication succeeds, encrypting the first random number and the second random number by the public key of the local key server in the local key server certificate, and sending an encrypted first ciphertext to the local key server;

the local key server decrypting the first ciphertext through a private key of the local key server, obtaining the first random number and the second random number, encrypting the second random number by the first random number to generate a second ciphertext, seeking the corresponding device authentication key pair and device encryption key pair according to the device identifier, encrypting a device authentication private key and a device encryption private key through the first random number to generate a third ciphertext, after the POS terminal passing a verification of the second ciphertext, sending the third ciphertext, the device authentication certificate and the device encryption certificate to the POS terminal;

the POS terminal verifying whether the device authentication certificate and the device encryption certificate are legal or not; if they are legal, decrypting the third ciphertext by the first random number to obtain the device authentication private key and the device encryption private key, and judging whether the device authentication private key and the device authentication public key are matching or not, and whether the device encryption private key and the device encryption public key are matching or not.

In connection with the first possible embodiment of the first aspect, in a third possible embodiment of the first aspect, after the step of the POS terminal sending a key setting request to a local key server, and the key setting request including a device identifier of the POS terminal, the method further includes:

the local key server certificate sending a certificate revocation list to the POS terminal;

the POS terminal judging whether the local key server certificate is valid or not according to the certificate revocation list.

In connection with the first aspect or the first possible embodiment of the first aspect, in a fourth possible embodiment of the first aspect, the steps of according to a remote authentication key pair set by the remote key server and the device authentication key pair of the POS terminal, the POS terminal and the remote key server authenticating with each other; after the authentication succeeds, bounding a certificate of the remote key server to the POS terminal device further includes:

the POS terminal sending a bounding request to the remote key server, the bounding request including a terminal identifier and a POS terminal authentication certificate;

the remote key server verifying whether the device authentication certificate of the POS terminal is legal or not, if it is legal, generating a remote key server authentication token, and encrypting the remote key server authentication token through the device authentication public key to generate a fourth ciphertext, and sending the fourth ciphertext and the remote key server certificate to the POS terminal;

after the POS terminal verifying that the remote key server certificate is legal, decrypting the fourth ciphertext through the device authentication private key to obtain the remote key server authentication token, and generating a device authentication token and a transmission key; encrypting the remote key server authentication token, the device authentication token and the transmission key by the remote key server public key to generate a fifth ciphertext, and sending the fifth ciphertext to the remote key server;

the remote key server decrypting the fifth ciphertext through the remote key server private key to obtain the remote key server authentication token, the device authentication token and the transmission key, if the decrypted remote key server authentication token matching with the remote key server token generated by the remote encryption server, the POS device authentication succeeding, and encrypting the device authentication token through the transmission key to obtain a sixth ciphertext and sending the sixth ciphertext to the POS terminal;

the POS terminal decrypting the sixth ciphertext according to the generated transmission key, and comparing the decrypted device authentication token with the device authentication token generated by the POS terminal, and if they match with each other, the remote key server authentication succeeding and the remote key server certificate being stored.

In connection with the fourth possible embodiment of the first aspect, in a fifth possible embodiment of the first aspect, the transmitting key is a temporary transmitting key, and the step of according to the device encryption key pair and a temporary transmission key, the POS terminal downloading the master key from the remote key server includes:

the remote key server encrypting the temporary transmission key through the public key of the device encryption key pair, the POS terminal decrypting to obtain the transmission key through the private key of the device encryption key pair, the remote key server encrypting the master key by the temporary transmission key to generate a sixth ciphertext, and the POS terminal decrypting the sixth ciphertext through the generated temporary transmission key to obtain the master key issued by the remote key server.

In a second aspect, another embodiment of the present application provides a key download apparatus for a POS terminal, the apparatus comprises:

a key pair setting unit configured for setting a device authentication key pair and a device encryption key pair in the POS terminal during a production or maintenance phase of the POS terminal;

an authenticating unit configured for according to a remote authentication key pair set by the remote key server and the device authentication key pair of the POS terminal, the POS terminal and the remote key server authenticating each other, after the authentication is succeed, bounding a certificate of the remote key server to the POS terminal device;

a downloading unit configured for according to the device encryption key pair and a temporary transmission key, the POS terminal downloading a master key from the remote key server.

In connection with the second aspect, in a first possible embodiment of the second aspect, the key pair setting unit is configured for:

randomly generating the device authentication key pair and the device encryption key pair in the POS terminal, or, randomly generating the device authentication key pair and the device encryption key pair by a manufacturer encryption machine, and sending a public key of the device authentication key pair and the device encryption key pair to a certificate registration authority to generate a device authentication key certificate and a device encryption certificate respectively.

In connection with the second aspect or the first possible embodiment of the second aspect, in a second possible embodiment of the second aspect, the key pair setting unit includes:

a request subunit configured for using the POS terminal sending a key setting request to a local key server, and the key setting request including a device identifier of the POS terminal;

an encryption subunit configured for using the POS terminal receiving and verifying a local key server certificate sent by the local key server, and generating a first random number and a second random number when the authentication succeeds, encrypting the first random number and the second random number by the public key of the local key server in the local key server certificate, and sending an encrypted first ciphertext to the local key server;

a verification subunit configured for using the local key server decrypting the first ciphertext through a private key of the local key server, obtaining the first random number and the second random number, encrypting the second random number by the first random number to generate a second ciphertext seeking the corresponding device authentication key pair and device encryption key pair, according to the device identifier, encrypting a device authentication private key and a device encryption private key through the first random number to generate a third ciphertext, after the POS terminal passing a verification of the second ciphertext, sending the third ciphertext, the device authentication certificate and the device encryption certificate to the POS terminal;

a matching subunit configured for using the POS terminal verifying whether the device authentication certificate and the device encryption certificate are legal or not; if they are legal, decrypting the third ciphertext by the first random number to obtain the device authentication private key and the device encryption private key, and judging whether the device authentication private key and the device authentication public key are matching or not, and whether the device encryption private key and the device encryption public key are matching or not.

In connection with the first possible embodiment of the second aspect, in a third possible embodiment of the second aspect, the apparatus further includes:

a certificate revocation list sending unit configured for using the local key server certificate sating a certificate revocation list to the POS terminal;

a certificate judging unit configured for using the POS terminal judging whether the local key server certificate is valid or not according to the certificate revocation list.

### Advantageous Effects

In the present application, in the production or maintenance phase, an asymmetric device encryption key pair and a device authentication key pair are set in advance in the POS terminal, and authenticate each other through the certificate corresponding to the public key of the POS terminal and the certificate corresponding to the public key of the remote key server; through the device encryption key pair and the temporary transmission key, the POS terminal downloads the master key from the remote key server. Since this method can download the master key through a network outside a security center, the security is high, the transportation cost can be saved, and the efficiency is high.

### BRIEF DESCRIPTION OF THE DRAWINGS

FIG. 1 is an implementation flowchart of a key download method of a POS terminal according to an embodiment of the present application;

FIG. 2 is an implementation flowchart of setting a key pair in a POS terminal provided by an embodiment of the present application;

FIG. 3 is an implementation flowchart of bounding a remote key server with a POS terminal according to an embodiment of the present application;

FIG. 4 is a structural schematic view of a key download apparatus of a POS terminal according to an embodiment of the present application.

### DETAILED DESCRIPTION OF THE EMBODIMENTS

To make the purposes, technical solutions, and advantages of the present application be clear, the present application will be further described in detail hereinafter with reference to accompanying drawings and embodiments. It should be understood that the specific embodiments described herein are merely intended to explain but not to limit the present application.

An object of the embodiments of the present application, among others, is to provide a key download method for a POS terminal, so as to solve the problems in the prior art that existing logistics costs and the efficiency of key injection is low. In order to ensure the security of the key of the POS terminal, it is usually necessary to transport the POS terminal to the security center for key downloading, on one hand, such an operation method will increase the transport costs of the POS terminal, because the POS terminals has to be transported from the merchant to the corresponding security center; then, the transport process consumes time, the efficiency of key downloading is low. The present application will be further described in detail hereinafter with reference to the accompanying drawings.

FIG. 1 is an implementation flowchart of a key download method of a POS terminal according to an embodiment of the present application, details as follows: [0049] In a step S101, setting a device authentication key pair and a device encryption key pair in the POS terminal during a production or maintenance phase of the POS terminal.

Specifically, the POS terminal described in the embodiments of the present application refers to a terminal device that can be used for non-cash settlement, such as obtaining an account number and the corresponding password of a bank card, transmitting the account number and the password to the bank server for conformation, receiving a confirmation information returned by the bank server, and thus completing the collection of the money in the bank card. Since the transmitted information includes sensitive information such as a bank card account number and the corresponding password, it is necessary to strictly ensure the security of the information transmission, it is necessary to set a secure key in the POS terminal, which is called as a master key in the present application. Moreover, the security of the master key must also be ensured during the setting or transmission of the master key.

The production or maintenance phase of the POS terminal means that the POS terminal is located at the site of the manufacturer, and the manufacturer can securely store data in the POS terminal. In the later period of the production phase, the assembly and testing of the POS terminal has been completed, and the preset of key pair of the POS terminal can be down before the product is packaged.

The device authentication key pair can be used for other devices to execute authentication of POS terminals. The device authentication public key of the device authentication key pair can be submitted to the certificate registration authority RA by the local key server, and the device authentication authority public key is signed by the certificate registration institution RA to generate a device authentication certificate. The local key server refers to a security server located within the manufacturer.

The device encryption key pair can be used to encrypt the data sent by the POS terminal using the device encryption public key, or to decrypt the received encrypted data using the device encryption private key. The device encryption public key can be submitted to the certificate registration authority RA by the local key server, and the device encryption authority key is signed by the certificate registration institution RA to generate a device encryption certificate.

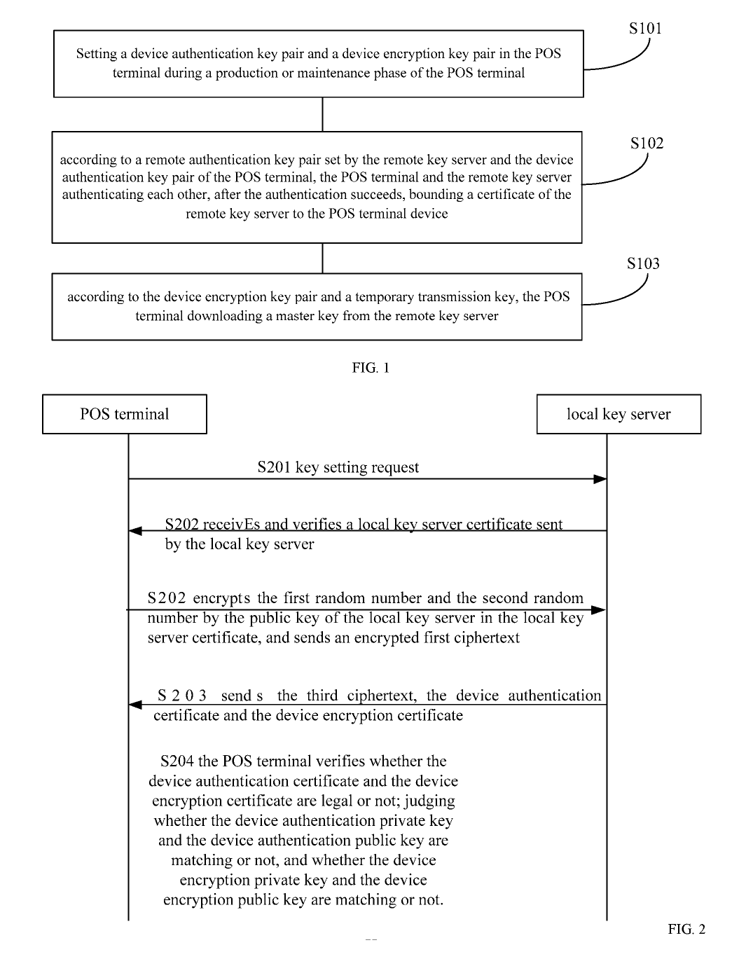

The device authentication key pair and the device encryption key pair can be generated randomly by the POS terminal or be generated randomly by the manufacturer encryption machine. Wherein, the process of the POS terminal setting a device authentication key pair and a device encryption key pair could specifically refer to FIG. 2.

In a step S201, the POS terminal sends a key setting request to a local key server, the key setting request includes a device identifier of the POS terminal.

Specifically, the device identifier of the POS terminal corresponds to the master key of the POS terminal. Used for finding a corresponding master key based on the device identifier of the POS terminal.

As an alternative embodiment of the present application, the POS terminal can transmit the key setting request from the local PC by connecting with a local PC, and receive the data sent by the local key server by the local PC.

In a Step S202, the POS terminal receives and verifies a local key server certificate sent by the local key server, and generating a first random number and a second random number when the authentication is succeed, encrypting the first random number and the second random number by the public key of the local key server in the local key server certificate, and sending an encrypted first ciphertext to the local key server.

The local key server can transmit a local key server authentication certificate to a POS terminal (data is transferred by a local PC connected to the POS terminal), and the POS terminal sends the local key server authentication certificate to the certificate issuing center to authenticate whether the certificate is a certificate of the local key server or not.

On this basis, the embodiments of POS terminal which can be further optimized includes: the POS terminal receives the issuing certificate revocation list sent by the local key server, and the POS terminal authenticates whether the certificate is valid or not according to the certificate revocation list. So that it can be more effectively to determine the security of the local key server, such as validity and authenticity and so on.

After authenticating the local key server, the POS terminal generates a first random number and a second random number, and encrypts the local key server public key in the local key server certificate to generate the first ciphertext. The first ciphertext includes the encrypted first random number and the second random number.

In a step S203, the local key server decrypts the first ciphertext through a private key of the local key, obtains the first random number and the second random number, encrypts the second random number by the first random number to generate a second ciphertext, seeking the corresponding device authentication key pair and the device encryption key pair according to the device identifier, encrypts a device authentication private key and a device encryption private key through the first random number to generate a third ciphertext, after the POS terminal passing a verification of the second ciphertext, sending the third ciphertext, the device authentication certificate and the device encryption certificate to the POS terminal.

The local key server decrypts the first ciphertext by the local key server private key to obtain a first random number and a second random number. The second ciphertext can be generated by encrypting the second random number with the first random number. The method of the first random number encrypting the second random number encryption can be a generic encryption algorithm, and the second random number can be obtained by the encryption algorithm on the premise that the first random number is known. Furthermore, the device authentication private key and the device encryption private key is encrypted by the first random number to generate a third ciphertext.

The POS terminal receives the second ciphertext, decrypts the second ciphertext by the first random number, and obtains a decrypted second random number. If the second random number obtained by the decryption is different from the randomly generated second random number, the authentication of the local key server fails and the flow is aborted.

If the second random number obtained by the decryption is equal to the randomly generated second random number, the third ciphertext sent by the local key server is received and the third ciphertext is decrypted by the first random number to obtain a device authentication private key and a device encryption private key.

In a step S204, the POS terminal verifies whether the device authentication certificate and the device encryption certificate are legal or not; if they are legal, decrypts the third ciphertext by the first random number to obtain the device authentication private key and the device encryption private key, and judges whether the device authentication private key and the device authentication public key are matching or not, and whether the device encryption private key and the device encryption public key are matching or not.

After decrypting the third ciphertext to obtain a device authentication private key and a device encryption private key, the device authentication private key can be matching judged with the device authentication public key. A data can be encrypted by the device authentication public key, and then be decrypted by the device authentication private key to determine whether the decrypted data is the same as the encrypted data, so that to authenticate whether the device authentication public key is match with the device authentication private key or not. By the same token, whether the device encryption public key matches the device encryption private key or not can be verified.

In a step S102, according to a remote authentication key pair set by the remote key server and the device authentication key pair of the POS terminal, the POS terminal and the remote key server authenticating each other; after the authentication succeeds, bounding a certificate of the remote key server to the POS terminal device.

After the device authentication key pair and the device encryption key pair are set in the POS terminal, the POS terminal is sold to the receiving agency, the receiving agency downloads the master key from the remote key server according to the key pair set in the POS terminal, the data transmission security request of the POS terminal is enhanced by encrypting the sensitive information data through the master key.

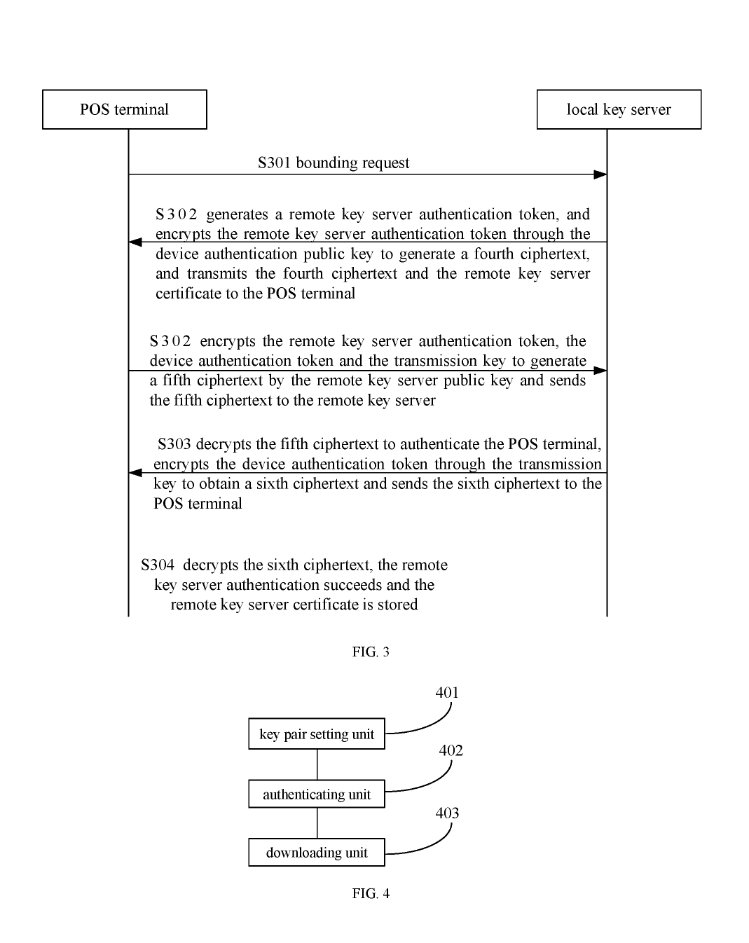

The POS terminal needs to be bound to a preset remote key server, which could include the following steps as shown in FIG. 3:

In a step S301, the POS terminal sending a bounding request to the remote key server, the bounding request including a POS terminal authentication certificate and a terminal identifier.

Specifically, the POS terminal needs to be bound to the remote key server, and obtains the master key for encrypting the data through the remote key server. Since the master key of the different receiving agency is different, it is necessary to set the corresponding master key by the remote key server after the receiving agency is determined. The bounding request could include information such as a POS terminal authentication certificate and a receiving agency's name of a POS terminal.

In a step S302, the remote key server verifies whether the device authentication certificate of the POS terminal is legal or not, if it is legal, generates a remote key server authentication token, and encrypts the remote key server authentication token through the device authentication public key to generate a fourth ciphertext, and sends the fourth ciphertext and the remote key server certificate to the POS terminal.

The remote key server verifies whether the device authentication certificate of the POS terminal is legal or not, if it is legal, then randomly generates a remote key server authentication token, and encrypts the remote key server authentication token through the device authentication public key to generate a fourth ciphertext, and sends the fourth ciphertext and the remote key server certificate to the POS terminal.

In a step S303, after the POS terminal verifying that the remote key server certificate is legal, decrypting the fourth ciphertext through the device authentication private key to obtain the remote key server authentication token, and generating a device authentication token and a transmission key, encrypting the remote key server authentication token, the device authentication token and the transmission key by the remote key server public key to generate a fifth ciphertext, and sending the fifth ciphertext to the remote key server.

After receiving the remote key server certificate, the POS terminal sends a verification request to the certificate server to determine whether the certificate name of the remote key server is the same as the remote server name, and if it is the same, the verification is completed. In addition, it is possible to receive a list of invalid revocation certificates issued by the remote key server to determine whether the remote key server certificate is a revoked certificate.

If the remote key server certificate is legal, the fourth ciphertext is decrypted by the device authentication private key to obtain a remote key server authentication token included in the fourth ciphertext. And generating a device authentication token and a transmission key, and encrypting the remote key server authentication token, the device authentication token and the transmission key through the remote key server public key to generate a fifth ciphertext.

The transmission key can be used to encrypt and decrypt the transmitted content, which could be a symmetric key.

In a step S304, the remote key server decrypts the fifth ciphertext through the remote key server private key to obtain the remote key server authentication token, the device authentication token and the transmission key, if the decrypted remote key server authentication token matches with the remote key server token generated by the remote encryption server, the POS device authentication succeeding, and encrypting the device authentication token through the transmission key to obtain a sixth ciphertext and sending the sixth ciphertext to the POS terminal.

The remote key server decrypts the fifth ciphertext through the remote key server private key to obtain the remote key server authentication token, the device authentication token and the transmission key, if the decrypted remote key server authentication token matches the remote key server token generated by the remote encryption server, then the authentication of the POS device succeeds.

The device authentication token is encrypted by the decrypted transmission key to generate a sixth ciphertext, and transmits the sixth ciphertext to the POS terminal.

In a step S305, the POS terminal decrypting the sixth ciphertext according to the generated transmission key, and comparing the decrypted device authentication token with the device authentication token generated by the POS terminal, and if they match with each other, the remote key server authentication succeeding and the remote key server certificate being stored.

The POS terminal decrypts the sixth ciphertext according to the generated transmission key to obtain a device authentication token, if the decrypted device authentication token is consistent with the generated device authentication token, it indicates that the remote key server holds the remote key server private key and can be authenticated by the remote key server to complete the authentication. Thereby completing bidirectional authentication and bounding the certificate of the remote key server.

In a step S103, according to the device encryption key pair and a temporary transmission key, the POS terminal downloads the master key from the remote key server.

After completing the bidirectional authentication of the POS terminal and the remote key server, the master key can be downloaded from the remote key server to complete the secure download of the master key of the POS terminal. The process of downloading a master key including: the remote key server generating a random number as the transmission key, the remote key server encrypting the temporary transmission key through the public key of the device encryption key pair, and the POS terminal decrypting the private key by the encryption key of the device to obtain the transmission key, the remote key server encrypting the master key by the temporary transmission key to generate a sixth ciphertext, and the POS terminal decrypting the sixth ciphertext through the generated temporary transmission key to obtain the master key issued by the remote key server.

After authenticating the POS terminal, the transmission key is encrypted by the POS terminal and sent to the remote key server, the remote key server decrypts the transmission key to obtain the master key which needs to be downloaded by the transmission key, thus completing the download of the master key and effectively guarantee the security of the master key download.

FIG. 4 is a structural schematic view of a key download apparatus of a POS terminal according to an embodiment of the present application, and is described in detail as follows:

The key download apparatus for POS terminal of the embodiments of the present application comprising:

a key pair setting unit 401 configured for setting a device authentication key pair and a device encryption key pair in the POS terminal during a production or maintenance phase of the POS terminal;

an authenticating unit 402 configured for according to a remote authentication key pair set by the remote key server and the device authentication key pair of the POS terminal, the POS terminal and the remote key server authenticating each other, after the authentication is succeed, bounding a certificate of the remote key server to the POS terminal device;

a downloading unit 403 configured for according to the device encryption key pair and a temporary transmission key, the POS terminal downloading a master key from the remote key server.

Preferably, the key pair setting unit is configured for:

randomly generating the device authentication key pair and the device encryption key pair in the POS terminal, or, randomly generating the device authentication key pair and the device encryption key pair by a manufacturer encryption machine, and sending a public key of the device authentication key pair and the device encryption key pair to a certificate registration authority to generate a device authentication key certificate and a device encryption certificate respectively.

Preferably, the key pair setting unit including:

a request subunit configured for using the POS terminal sending a key setting request to a local key server, and the key setting request including a device identifier of the POS terminal;

an encryption subunit configured for using the POS terminal receiving and verifying a local key server certificate sent by the local key server, and generating a first random number and a second random number when the authentication succeeds, encrypting the first random number and the second random number by the public key of the local key server in the local key server certificate, and sending an encrypted first ciphertext to the local key server;

a verification subunit configured for using the local key server decrypting the first ciphertext through a private key of the local key server, obtaining the first random number and the second random number, encrypting the second random number by the first random number to generate a second ciphertext, seeking the corresponding device authentication key pair and the device encryption key pair according to the device identifier, encrypting a device authentication private key and a device encryption private key through the first random number to generate a third ciphertext, after the POS terminal passing a verification of the second ciphertext, sending the third ciphertext, the device authentication certificate and the device encryption certificate to the POS terminal;

a matching subunit configured for using the POS terminal verifying whether the device authentication certificate and the device encryption certificate are legal or not; if they are legal, decrypting the third ciphertext by the first random number to obtain the device authentication private key and the device encryption private key, and judging whether the device authentication private key and the device authentication public key are matching or not, and whether the device encryption private key and the device encryption public key are matching or not.

Preferably, the apparatus further including:

a certificate revocation list sending unit configured for using the local key server certificate issuing a certificate revocation list to the POS terminal;

a certificate judging unit configured for using the POS terminal judging whether the local key server certificate is valid or not according to the certificate revocation list.

The key download apparatus of the POS terminal shown in FIG. 4 corresponds to the key download method of the POS terminal described in FIGS. 1 to 3, and is not repeated here.

In the several embodiments according to the present application, it should be understood that the disclosed apparatus and method could be implemented in other ways. For example, the apparatus embodiments described above are merely illustrative, for example, the division of the units is only a logical function division, and additional division could be used in the actual implementation, such as multiple units or components could be combined or be integrated into another system, or some features could be ignored or not performed. In addition, the direct coupling or indirect coupling or communication connection between the units shown or discussed could be an indirect coupling or communication connection of some interfaces, devices or units, which could be electrical, mechanical, or otherwise.

The units described as a separation assembly could or could not be physically separated, and the components shown as units could or could not be physical units, i.e., they could be located in one place or could be distributed over a plurality of network elements. Parts or all of the elements could be selected according to the actual needs to achieve the object of the present embodiment.

In addition, the functional units in the various embodiments of the present application could be integrated in one processing unit, or each unit could be physically present, or two or more units could be integrated in one unit. The above-mentioned integrated units can be implemented either in the form of hardware or in the form of software functional units.

The integrated unit could be stored in a computer-readable storage medium if it is implemented in the form of a software functional unit and sold or used as a separate product. Based on this understanding, the technical solution of the present application essentially, or the parts contributed to the prior art, or all or parts of the technical solution could be embodied in the form of a software product, the computer software product is stored in a storage medium and includes instructions for causing a computer device (which could be a personal computer, a server, or a network device, etc.) to perform all or parts of the method described in the various embodiments of the present application. And the aforementioned storage medium includes: a USB disk, a removable hard disk, a read-only memory (ROM), a random access memory (RAM), a magnetic disk, or a disc, and other medium which could store procedure code.

The foregoing description are only preferred embodiments of the present application and are not intended to limit the present invention, any modifications, equivalent substitutions and improvements within the spirit and principles of the invention are intended to be included within the scope of the present invention.

1. A key download method for POS terminal, wherein the method comprising:
setting a device authentication key pair and a device encryption key pair in the POS terminal during a production or maintenance phase of the POS terminal;
according to a remote authentication key pair set by the remote key server and the device authentication key pair of the POS terminal, the POS terminal and the remote key server authenticating each other; after the authentication succeeds, bounding a certificate of the remote key server to the POS terminal device;
according to the device encryption key pair and a temporary transmission key, the POS terminal downloading the master key from the remote key server.

2. A method according to claim 1, wherein, the steps of setting the device authentication key pair and the device encryption key pair in the POS terminal includes:
randomly generating the device authentication key pair and the device encryption key pair in the POS terminal, or alternatively randomly generating the device authentication key pair and the device encryption key pair by a manufacturer encryption machine, and
sending a public key in the device authentication key pair and the device encryption key pair to a certificate registration authority to generate a device authentication key certificate and a device encryption certificate respectively.

3. A method according to claim 1, wherein, the steps of setting the device authentication key pair and the device encryption key pair in the POS terminal includes:
the POS terminal sending a key setting request to a local key server, and the key setting request including a device identifier of the POS terminal;
the POS terminal receiving and verifying a local key server certificate sent by the local key server, and generating a first random number and a second random number when the authentication is succeed, encrypting the first random number and the second random number by the public key of the local key server in the local key server certificate, and sending an encrypted first ciphertext to the local key server;
the local key server decrypts the first ciphertext through a private key of the local key server, obtaining the first random number and the second random number, encrypting the second random number by the first random number to generate a second ciphertext, seeking the corresponding device authentication key pair and the device encryption key pair according to the device identifier, encrypting a device authentication private key and a device encryption private key through the first random number to generate a third ciphertext, after the POS terminal passing a verification of the second ciphertext, sending the third ciphertext, the device authentication certificate and the device encryption certificate to the POS terminal;
the POS terminal verifying whether the device authentication certificate and the device encryption certificate are legal or not; if they are legal, decrypting the third ciphertext by the first random number to obtain the device authentication private key and the device encryption private key, and judging whether the device authentication private key and the device authentication public key are matching or not, and whether the device encryption private key and the device encryption public key are matching or not.

4. A method according to claim 2, wherein, after the POS terminal sending a key setting request which includes a device identifier of the POS terminal to a local key server, the method further includes:
the local key server certificate sending a certificate revocation list to the POS terminal;
the POS terminal judging whether the local key server certificate is valid or not according to the certificate revocation list.

5. A method according to claim 1, wherein, after the steps of according to a remote authentication key pair set by the remote key server and the device authentication key pair of the POS terminal, the POS terminal and the remote key server are authenticated with each other, and after the authentication succeeds, the steps of bounding a certificate of the remote key server to the POS terminal device further includes:
the POS terminal sending a bounding request to the remote key server, the bounding request including a terminal identifier and a POS terminal authentication certificate;
the remote key server verifying whether the device authentication certificate of the POS terminal is legal or not, if it is legal, generating a remote key server authentication token, and encrypting the remote key server authentication token through the device authentication public key to generate a fourth ciphertext, and sending the fourth ciphertext and the remote key server certificate to the POS terminal;
after the POS terminal verifying that the remote key server certificate is legal, decrypting the fourth ciphertext through the device authentication private key to obtain the remote key server authentication token, and generating a device authentication token and a transmission key; encrypting the remote key server authentication token, the device authentication token and the transmission key by the remote key server public key to generate a fifth ciphertext, and sending the fifth ciphertext to the remote key server;
the remote key server decrypting the fifth ciphertext through the remote key server private key to obtain the remote key server authentication token, the device authentication token and the transmission key, if the decrypted remote key server authentication token matching with the remote key server token generated by the remote encryption server, the POS device authentication succeeding, and encrypting the device authentication token through the transmission key to obtain a sixth ciphertext and sending the sixth ciphertext to the POS terminal;
the POS terminal decrypting the sixth ciphertext according to the generated transmission key, and comparing the decrypted device authentication token with the device authentication token generated by the POS terminal, and if they match with each other, the remote key server authentication succeeding and the remote key server certificate being stored.

6. A method according to claim 5, wherein, the transmission key is a temporary transmission key, the steps of according to the device encryption key pair and a temporary transmission key, the POS terminal downloading the master key from the remote key server includes:
the remote key server encrypting the temporary transmission key through the public key of the device encryption key pair, the POS terminal decrypting to obtain the transmission key through the private key of the device encryption key, the remote key server encrypting the master key by the temporary transmission key to generate a sixth ciphertext, and the POS terminal decrypting the sixth ciphertext through the generated temporary transmission key to obtain the master key issued by the remote key server.

7. A key download apparatus for POS terminal, wherein the apparatus comprises:
a key pair setting unit configured for setting a device authentication key pair and a device encryption key pair in the POS terminal during a production or maintenance phase of the POS terminal;
an authenticating unit configured for according to a remote authentication key pair set by the remote key server and the device authentication key pair of the POS terminal, enabling the POS terminal and the remote key server authenticating each other, after the authentication is succeed, bounding a certificate of the remote key server to the POS terminal device;
a downloading unit configured for according to the device encryption key pair and a temporary transmission key, enabling the POS terminal downloading a master key from the remote key server.

8. An apparatus according to claim 7, wherein, the key pair setting unit is configured for:
randomly generating the device authentication key pair and the device encryption key pair in the POS terminal, or, randomly generating the device authentication key pair and the device encryption key pair by a manufacturer encryption machine, and sending a public key of the device authentication key pair and the device encryption key pair to a certificate registration authority to generate a device authentication key certificate and a device encryption certificate respectively.

9. An apparatus according to claim 8, wherein, the key pair setting unit includes:
a request subunit configured for using the POS terminal sending a key setting request to a local key server, and the key setting request including a device identifier of the POS terminal;
an encryption subunit configured for using the POS terminal receiving and verifying a local key server certificate sent by the local key server, and generating a first random number and a second random number when the authentication succeeds, encrypting the first random number and the second random number by the public key of the local key server in the local key server certificate, and sending an encrypted first ciphertext to the local key server;
a verification subunit configured for using the local key server decrypting the first ciphertext through a private key of the local key server, obtaining the first random number and the second random number, encrypting the second random number by the first random number to generate a second ciphertext, seeking the corresponding device authentication key pair and a device encryption key pair according to the device identifier, encrypting a device authentication private key and a device encryption private key through the first random number to generate a third ciphertext, after the POS terminal passing verification of the second ciphertext sending the third ciphertext, the device authentication certificate and the device encryption certificate to the POS terminal;
a matching subunit configured for using the POS terminal verifying whether the device authentication certificate and the device encryption certificate are legal or not; if they are legal, decrypting the third ciphertext by the first random number to obtain the device authentication private key and the device encryption private key, and judging whether the device authentication private key and the device authentication public key are matching or not, and whether the device encryption private key and the device encryption public key are matching or not.

10. An apparatus according to claim 8, wherein, the apparatus further includes:
a certificate revocation list sending unit configured for using the local key server certificate issuing a certificate revocation list to the POS terminal;
a certificate judging unit configured for using the POS terminal judging whether the local key server certificate is valid or not according to the certificate revocation list.
